(19) United States
(12) Patent Application Publication
(10) Pub. No.: US 2024/0182688 A1
(43) Pub. Date: Jun. 6, 2024

(54) HIGHLY POROUS MATERIALS OF CELLULOSE FROM AGRICULTURAL RESIDUES

(71) Applicants: Deutsches Zentrum Für Luft- Und Raumfahrt E.V., Bonn (DE); University of British Columbia, Vancouver (CA)

(72) Inventors: Kathirvel GANESAN, Cologne (DE); Barbara MILOW, Hürth (DE); Sahar ALOUSI, Vancouver (CA); Michael DEYHOLOS, Vancouver (CA); Sepideh PAKPOUR, Vancouver (CA)

(21) Appl. No.: 18/284,624

(22) PCT Filed: Mar. 31, 2022
(86) PCT No.: PCT/EP2022/058701

§ 371 Date: Sep. 28, 2023

(30) Foreign Application Priority Data
Mar. 31, 2021 (DE) 10 2021 108 166.1

(51) Int. Cl. C08L 1/02; B01J 20/24; B01J 20/28; B01J 20/30; C08B 1/00

(52) U.S. Cl. CPC C08L 1/02; B01J 20/24; B01J 20/28016; B01J 20/28042; B01J 20/28047; B01J 20/3085; C08B 1/003

(57) ABSTRACT

The present invention relates to a process for the manufacturing of bio-based aerogels derived from crystalline cellulose extracted from plants' fiber agricultural residues, and bio-based aerogels by said process.

### CROSS-REFERENCE TO RELATED APPLICATION(S)

This application is a U.S. National Stage Entry Under 35 U.S.C. 371 of International Application No. PCT/EP2022/058701 filed on Mar. 31, 2022, which claims priority to DE 10 2021 108 166.1 filed on Mar. 31, 2021, the contents of which are incorporated herein by reference in their entireties.

### FIELD OF THE INVENTION

The present invention relates to a process for the manufacturing of bio-based aerogels derived from crystalline cellulose extracted from plants' fiber waste, also known as fiber residues, and bio-based aerogels by said process.

### BACKGROUND OF THE INVENTION

Hemp is an industrial plant which is grown globally under restrictive laws and regulations (Pargar et al., 2020). This crop is mainly cultivated for its seed and fiber production and is defined by its very low amounts of psychoactive cannabinoid, having as low as 0.3% of THC. In Canada, the legalization of hemp cultivation dates back to the 1998 and is regulated by Health Canada as per Bill C45 (Pargar et al., 2020). Based on published numbers from Health Canada, a total of 77,800 acers of industrial hemp were planted in 2018. In Europe, hemp crops are grown for fiber production, but the current drivers for Canadian hemp production are the high demands for hemp grain (seed, and oil) which serve as a valuable food resource.

Although in Canada hemp is manly cultivated for its grain and oil production, hemp fibers are gaining more interest among the industrial sections. Hemp bast fibers have distinctive properties when compared to other bast fibres (e.g. kenaf, jute, flax or ramie). The fibers are characterized by their outstanding durability, absorbency, length, and anti-mildew and antimicrobial properties (Alberta Agriculture and Forestry, 2017, March). Some of the features such as fiber length, color, and fineness can highly influence the farm-gate price.

In addition, the plant's maturity stage, condition of retting, and quality of storage are all factors that affects the yield of straw, hence the cost returns per hectare (Ontario Ministry of Agriculture Food and Rural Affairs, 2009, August). It is worth mentioning that the best fiber's quality can be obtained from hemp varieties that are grown for fiber production and are not allowed to produce seeds, and these plants are usually not considered as dual purpose hemp crops (Canadian Hemp Trade Alliance, 2020b).

On a microscale level, cross sectional area of hemp stem contains both primary and secondary bast fiber (also called phloem fibers) bundles which are made up of 70-74% of cellulose, 15-20% hemicellulose, 3.5-5.7% lignin, 0.8% pectin, and 1.2-6.2% wax (Ranalli & Venturi, 2004; Sen & Reddy, 2011). The secondary produced fibers are short and highly lignified which renders them less desirable for most applications (Placet et al., 2014). A hemp plant is made up of 3 major parts: bast fiber making up 30%, hurd part making up 60%, and the chaff part making up 10% of the plant (Canadian Hemp Trade Alliance, 2020b). Following the harvesting process, a procedure called decortication of the straw can be applied for the separation of the straw's constituents. This process results in two major types of fibers called hurd and bast. Both of these resulting fibers can be used in a wide range of applications (Canadian Hemp Trade Alliance, 2020a).

This inner wood-like core fibers can be directed to “low end uses”, these include hemp concrete. On the other hand, the outer bast fibers can be used for better paying and technical markets (Canadian Hemp Trade Alliance, 2020b).

Canadian hemp producers are faced with major challenges associated with hemp production, which is biomass and residues disposal generated post-harvest of the plant. When it comes to medical cannabis the leaves, flowers and seeds are of great interest to the producers and the remaining vegetation is considered as plant residues. While, oil and grain producing hemp residues can be defined as the hemp stalk without flowers, seeds or leaves and is currently being disposed in landfills and accounts for large dry matter yield (about 10 tons per ha) (Alberta Agriculture and Forestry, 2017, March). Hemp vegetative biomass offers valuable components such as: fiber (the outer core) and accounts for 25-30% of the stalk, hurd (the inner part of the stalk) and dust (Alberta Agriculture and Forestry, 2017, March). To better understand the worth of plant residues or biowaste, hemp grown in two cites in Alberta, Canada were assessed for their physic-chemical properties. The cellulose content in the bast component of hemp stalk ranged between 57-65%, while the core (wood-like part) had 48% cellulose. Additionally, published numbers by the government of Alberta states that the total yield of hemp bast fibers is 2,697 kg/ha, and hemp core components is 5,543 kg/ha. Harnessing these plant residues can serve as a raw starting material for the curation of the most abundant biopolymer, cellulose (Alberta Agriculture and Forestry, 2017, March). The worldwide increase of hemp production is on the rise, and alternative solutions must come into play to ensure sustainable waste management.

When it comes to the current levels of production, hemp fibers are still not economically valuable as other residual fibers such as wood (or hurd) and straw, that are used in fiberboards and biofuels, respectively. Rather, their value can be recognized in modern manufacturing of products that require specific fiber properties and quality such as reinforced composites, therefore replacing fiber glass in these applications (Canadian Hemp Trade Alliance, 2020b). We are currently proposing a novel approach to convert the hemp short fiber residues to cellulose aerogels, with excellent mechanical properties and defined physical and chemical characteristics.

According to the flax council of Canada, the flax industry contributes annually an approximate of $300 million to the Canadian economy (Northen Alberta Development Council, 2017, July). When it comes to overall flax production across Canada, Alberta produces only about 9% of Canadian flax, and 93% of Alberta's flax product gets exported to Belgium, U.S.A., and China. Other emerging markets for Canadian flax are Korea, Germany and the Netherlands (Northen Alberta Development Council, 2017, July). According to the Saskatchewan Flax Development Commission, Canada is the world's largest producer and exporter of flax with annual exports valued at $150-180 million. As a result, market conditions in Canada have a significant impact on global flax prices (Saskatchewan Flax Development Commission, 2020a). It is worth mentioning that linseed or oil flax is the dominant crop in Canada, rather than the fibrous flax variety.

Among the important industrial plant species is Linum usitatissimum usually cultivated for seed production (linseed) or as a fiber crop. Flax fibers are among the most widely used bio-fibers, this is due to the short life cycle of the plant (Yan et al., 2014). In addition, fiber performance and fiber mechanical properties which have a similar range to glass fibers with an average fiber density of 1.53, elastic modulus of 52.4 GPa, strain at break of 2.15% and strength at break of 976 MPa (Lefeuvre et al., 2014) makes it a very attractive for industrial use. Chemical composition of flax fibers can be divided as follows: cellulose constitute 70-75% of the fiber, with other constituents 15-20% hemicellulose, 3% lignin, and 3% pectin (Van Dam & Gorshkova, 2003).

Presently, there is no use for flax straw after seed harvesting. Growing flax is usually associated with the “the straw management problem”. Oilseed flax has a substantial amount of long tough bast fibers that decay slowly over time. This makes it difficult to incorporate flax straw into the soil after harvest (Flax Council of Canada, 2020). Influenced by both the planted acreage and rainfall, flax straws are produced in a range of 500,000 to 1,000,000 tonnes annually (Flax Council of Canada, 2020). The oilseed flax straw usually contains fibers at a range of 15-25%. As such, the annual pure fiber production from flax grown in Canada would be between 75,000 and 250,000 tonnes (Flax Council of Canada, 2020). In general, the process of obtaining flax bast fibers is based on a traditional value-added chain consisting of field drying and retting of bast fiber crops. The procedure is followed by mechanical processing of dry straw by means of decortication and the separation of the fibers form the non-fibrous components of flax stalks (shives/hurds) (Gusovius et al., 2019).

If flax straws' get processed, they usually find their destination in the paper industry, specifically cigarette paper, and lower end plastic composites (Saskatchewan Flax Development Commission, 2020b). Other medium value uses of flax fibers include middle quality plastic composite, fertilizers, absorbent materials, insulating materials, geotextiles, and low-end textiles.

Flax fibers that are fed into the medium value industry are usually free of shives (which is the non-fiber parts of the stem), and has a uniform fiber diameter and length, and are usually partly or totally retted. These criteria add restrains to the choice of fibers used for medium value products. Industries processing such medium value products would usually characterize any flax fiber starting materials with short pieces of straw, plastic litter, weed seeds or stalks as undesirable for the final application(Saskatchewan Flax Development Commission, 2020b).

On the other hand, high end uses of flax fibers can include high-end plastic composites, and textile applications. For the purpose of these applications, flax fibers should be completely free of shives, have good strength, consistent length and distribution. Also, the stems' fibers should have a good and similar degree of retting to ensure fiber consistency. Any flax fibers that are extracted from unretted straws, has plastic litter, or short pieces of straw, seeds or seed holders would be categorized as unsuitable for high end uses (Saskatchewan Flax Development Commission, 2020b).

Developing valuable materials from Bio-waste valorization is seen to promote benefits to the environment. Concept of converting the Bio-wastes from agriculture to biopolymer-based aerogels is aimed. The Bio-wastes from agriculture have rich amounts of biopolymers such as cellulose, lignin, hemicellulose and other polysaccharides which can be utilized to produce demanding applied materials such as aerogels (Phanthong et al., 2018; Lohri et al., 2017; Wojnowska-Baryła et al., 2020).

Cellulose aerogels prepared from agricultural residues/wastepaper and cottons were demonstrated to be super thermal insulators (Li et al., 2011; Sun et al., 2020; Garemar et al., 2020; Song et al., 2018; Kaya & Tabak, 2020; Ha et al., 2015; Thai et al., 2019).

Technologies for the production of functionalized cellulose aerogels with reduced thermal and acoustic insulation properties and flame retardancy have been reported as well (Wicklein et al., 2014; Feng et al., 2016; Guo et al., 2018.). Highly porous wood-based materials were recently reported by delignifying method and removal of hemicellulose and wood skeletal structure was retained from its original with wood hierarchical porous structure (Sun et al., 2020; Garemark et al., 2020; Song et al., 2018). By this method, authors have isolated the cellulose rich wood materials. Further employing freeze drying technique wood-like highly porous materials were produced. The materials are named “wood aerogel”. Li et al., 2011 reported lignocellulose aerogel from wood powder. Ionic liquid, 1-allyl-3-methylimidazolium chloride was used as solvent to prepare gels which then converted to aerogel by supercritical CO₂ drying. The final aerogel had two components which are non-dissolved wood part and interconnected nanofibrillar cellulose network.

In literatures, various methods of the extraction of cellulose-rich raw products was reported and it can be achieved by known chemical methods such as acid and/alkali hydrolysis followed by surface treatment with oxidizing medium (e.g., hypochlorite or peroxide) (Łukajtis et al., 2018; Ng et al., 2015; Trilokesh & Uppuluri 2019). In our experiments, we have employed alkali hydrolysis (NaOH) followed by bleaching using (KOH and H₂O₂). Typically, agricultural plant materials have a mixture of amorphous and crystalline regions. The crystalline amount can vary between 40 and 60%. During the extraction process, most of the lignin and hemicellulose can be removed out and cellulose rich raw products can be collected. Mostly, the crystallinity of this raw cellulose is cellulose I. Cellulose wet gels can be prepared by physical dissolution (e.g., molten salt hydrate or sodium hydroxide-water-urea) and regeneration methods (Wang & Zhang 2016; Budtova, 2019; Budtova & Navard 2016; Buchtová & Budtova, 2016; Ciolacu, et al., 2016; Habibi & Lucia, 2012; Liebner et al., 2015; Liebner et al., 2008) or by mechanical disintegration of fibers via ultrasonication (Pääkkö, et al., 2008; Kobayashi et al., 2014; Sehaqui et al., 2010; Svagan et al., 2007). The wet alcogels can be converted to aerogels by supercritical drying. After preparing aerogels by regeneration methods from solution, the crystallinity is mostly degraded to cellulose II.

Since 1818, regenerated cellulose, i.e., “cellulose II”, often called man-made cellulose is commercially produced in the form of fibres in Textile industries in the name of RAYON or VISCOSE. These fibres are produced by dissolution of “cellulose I” in Cupro method (water-copper-ammonium salts, producing RAYON), in viscose method (NaOH-water and CS2 as solvent, producing VISCOSE) and Lyocell method (N-methyl morpholine N-oxide (NMMO) as solvent, also producing VISCOSE).

Cellulose I is a high crystalline material found in nature having parallel arrangement of molecular chain whereas cellulose II is a low crystalline material (not found in nature). In the dissolution process of cellulose I crystals, the molecules are disintegrated from the crystalline domain and in the regeneration process, they aggregate to form antiparallel aggregated structure, i.e., insoluble cellulose II. In general, it can be said that cellulose I powder (thermodynamically metastable) is converted to cellulose II (very stable).

Thus, it can be understood that NaOH-water based solvent systems together with some additives such as CS2, urea, etc, have been used in the industries for the dissolution of cellulose. This concept of dissolution of cellulose I using different solvents and regeneration of cellulose II was utilized by many groups of scientists for the production of classical aerogels.

Other methods reporting in preparation of cellulose I aerogels from cellulose nanocrystals, cellulose nanowhiskers and cellulose nanofibers. In this process, no dissolution of cellulose occurs. Cellulose I nanomaterials may have surface functional groups depending upon the method of production of cellulose nanomaterials. Mostly cellulose nanomaterials are dispersed in water medium prior to gelation. Mechanical, heat or chemical (acid or alkali) treatments can induce the self-assembly of nanostructures in a random fashion forming wet-gel network by percolation of the nanomaterials (using van der Waals forces). Once wet-gel network is formed, further washing, solvent exchange and supercritical drying (sometimes freeze drying is appropriate) processes can assist the aerogel production.

The concept and terminology of aerogel was first brought up by Kistler in 1932. The term designates a gel like material with its liquid content being replaced with gas, but without collapsing the solid interconnected network of the gel (Kistler, 1932). While the process of aerogel development was known to be a complicated multistage preparation procedure. Recent advancements in the manufacturing technologies allowed for the preparation of different types of aerogels, for example inorganic aerogels prepared from SiO₂, TiO₂, SnO₂, V₂O₅, and Al₂O₃ (Baumann et al., 2005; Corrias et al., 2004; Le et al., 1996; Leventis et al., 2002; Masson et al., 1996), natural macromolecule-based aerogels from alginate, protein, chitosan, and hemicellulose (Betz et al., 2012; Chang et al., 2008; Deze et al., 2012; García-González et al., 2011; Salam et al., 2011), carbon aerogels from carbon, carbon nanotubes and graphene(Aliev et al., 2009; Fairen-Jiménez et al., 2006; Worsley et al., 2010), and synthetic polymer-based aerogels made from resorcinol-formaldehyde, polyvinylchloride, polypropylene and polyimide (Al-Muhtaseb & Ritter, 2003; Daniel et al., 2008; Guo et al., 2012; Yamashita et al., 2003) can be easily prepared. When it comes to bio-aerogel synthesis, cellulose serves as a convenient macromolecule, while being the most abundance biopolymer on earth (Long et al., 2018) and being entirely compostable and biocompatible. Cellulose derived materials such as cellulose fibers, cellulose composites, cellulose-based films, and cellulose hydrogels and aerogels, all hold immense potential benefits when compared to synthesized polymer equivalents (Moreno-Castilla & Maldonado-Hódar, 2005).
Al-Muhtaseb, S. A., & Ritter, J. A. (2003). Preparation and properties of resorcinol-formaldehyde organic and carbon gels. Advanced Materials, 15(2), 101-114;
Alberta Agriculture and Forestry. (2017, March). Industrial hemp enterprise https://www1.agric.gov.ab.ca/$department/deptdocs.nsf/all/agdex126/$file/153-830-1.pdf;
Aliev, A. E., Oh, J., Kozlov, M. E., Kuznetsov, A. A., Fang, S., Fonseca, A. F., Ovalle, R., Lima, M. D., Haque, M. H., & Gartstein, Y. N. (2009). Giantstroke, superelastic carbon nanotube aerogel muscles. science, 323(5921), 1575-1578;
Baumann, T. F., Kucheyev, S. O., Gash, A. E., & Satcher Jr, J. H. (2005). Facile synthesis of a crystalline, high-surface-area SnO2 aerogel. Advanced Materials, 17(12), 1546-1548;
Betz, M., García-González, C., Subrahmanyam, R., Smirnova, I., & Kulozik, U. (2012). Preparation of novel whey protein-based aerogels as drug carriers for life science applications. The Journal of Supercritical Fluids, 72, 111-119;
Buchtova, N., & Budtova, T. (2016). Cellulose aero-, cryo- and xerogels: Towards understanding of morphology control. Cellulose, 23(4), 2585-2595;
Budtova, T., & Navard, P. (2016). Cellulose in NaOH-water based solvents: a review. Cellulose, 23(1), 5-55;
Budtova, T. (2019). Cellulose II aerogels: A review. Cellulose, 26(1), 81-121;
Canadian Hemp Trade Alliance. (2020a). Fibre processing http://www.hemptrade.ca/eguide/fibre-production/fibre-processing;
Canadian Hemp Trade Alliance. (2020b). Grow hemp. http://www.hemptrade.ca/grow-hemp;
Chang, X., Chen, D., & Jiao, X. (2008). Chitosan-based aerogels with high adsorption performance. The Journal of Physical Chemistry B, 112(26), 7721-7725;
Ciolacu, D., Rudaz, C., Vasilescu, M., & Budtova, T. (2016). Physically and chemically cross-linked cellulose cryogels: Structure, properties and application for controlled release. Carbohydrate polymers, 151, 392-400;
Corrias, A., Casula, M. F., Falqui, A., & Paschina, G. (2004). Preparation and characterization of FeCo—Al₂O₃ and Al₂O₃ aerogels. Journal of sol-gel science and technology, 31(1-3), 83-86;
Daniel, C., Sannino, D., & Guerra, G. (2008). Syndiotactic polystyrene aerogels: adsorption in amorphous pores and absorption in crystalline nanocavities. Chemistry of Materials, 20(2), 577-582;
Deze, E. G., Papageorgiou, S. K., Favvas, E. P., & Katsaros, F. K. (2012). Porous alginate aerogel beads for effective and rapid heavy metal sorption from aqueous solutions: Effect of porosity in Cu²⁺ and Cd²⁺ ion sorption. Chemical Engineering Journal, 209, 537-546;
Fairen-Jiménez, D., Carrasco-Marín, F., & Moreno-Castilla, C. (2006). Porosity and surface area of monolithic carbon aerogels prepared using alkaline carbonates and organic acids as polymerization catalysts. Carbon, 44(11), 2301-2307;
Feng, J., Le, D., Nguyen, S. T., Nien, V. T. C., Jewell, D., & Duong, H. M. (2016). Silica□ cellulose hybrid aerogels for thermal and acoustic insulation applications. Colloids and Surfaces A: Physicochemical and Engineering Aspects, 506, 298-305;
Flax Council of Canada. (2020). Chapter 12: Flax straw and fibre. https://flaxcouncil.ca/growing-flax/chapters/flax-straw-and-fibre/;
García-González, C., Alnaief, M., & Smirnova, I. (2011). Polysaccharide-based aerogels-Promising biodegradable carriers for drug delivery systems. Carbohydrate Polymers, 86(4), 1425-1438;
Garemark, J., Yang, X., Sheng, X., Cheung, O., Sun, L., Berglund, L. A., & Li, Y. (2020). Top-Down Approach Making Anisotropic Cellulose Aerogels as Universal Substrates for Multifunctionalization. ACS nano, 14(6), 7111-7120;
Guo, H., Meador, M. A. B., Mccorkle, L., Quade, D. J., Guo, J., Hamilton, B., & Cakmak, M. (2012). Tailoring properties of cross-linked polyimide aerogels for better moisture resistance, flexibility, and strength. ACS applied materials & interfaces, 4(10), 5422-5429;
Guo, L., Chen, Z., Lyu, S., Fu, F., & Wang, S. (2018). Highly flexible cross-linked cellulose nanofibril sponge-like aerogels with improved mechanical property and enhanced flame retardancy. Carbohydrate polymers, 179, 333-340;
Gusovius, H.-J., Lühr, C., Hoffmann, T., Pecenka, R., & Idler, C. (2019). An alternative to field retting: fibrous materials based on wet preserved hemp for the manufacture of composites. Agriculture, 9(7), 140;
Habibi, Y., & Lucia, L. A. (2012). Polysaccharide building blocks: a sustainable approach to the development of renewable biomaterials. John Wiley & Sons;
Han, Y., Zhang, X., Wu, X., & Lu, C. (2015). Flame retardant, heat insulating cellulose aerogels from waste cotton fabrics by in situ formation of magnesium hydroxide nanoparticles in cellulose gel nanostructures. ACS Sustainable Chemistry & Engineering, 3(8), 1853-1859;
Kaya, M., & Tabak, A. (2020). Recycling of an agricultural bio-waste as a novel cellulose aerogel: A green chemistry study. Journal of Polymers and the Environment, 28(1), 323-330;
Kistler, S. (1932). Coherent expanded aerogels. Rubber Chemistry and Technology, 5(4), 600-603;
Kobayashi, Y., Saito, T., & Isogai, A. (2014). Aerogels with 3D ordered nanofiber skeletons of liquid-crystalline nanocellulose derivatives as tough and transparent insulators. Angewandte Chemie International Edition, 53(39), 10394-10397;
Le, D., Passerini, S., Guo, J., Ressler, J., Owens, B., & Smyrl, W. H. (1996). High surface area V2O5 aerogel intercalation electrodes. Journal of the Electrochemical Society, 143(7), 2099;
Lefeuvre, A., Bourmaud, A., Morvan, C., & Baley, C. (2014). Tensile properties of elementary fibres of flax and glass: Analysis of reproducibility and scattering. Materials Letters, 130, 289-291;
Leventis, N., Sotiriou-Leventis, C., Zhang, G., & Rawashdeh, A.-M. M. (2002). Nanoengineering strong silica aerogels. Nano letters, 2(9), 957-960;
Li, J., Lu, Y., Yang, D., Sun, Q., Liu, Y., & Zhao, H. (2011). Lignocellulose aerogel from wood-ionic liquid solution (1-allyl-3-methylimidazolium chloride) under freezing and thawing conditions. Biomacromolecules, 12(5), 1860-1867;
Liebner, F., Pircher, N., Schimper, C., Haimer, E., & Rosenau, T. (2015). Aerogels: cellulose-based. Encyclopedia of Biomedical Polymers and Polymeric Biomaterials; Mishra, M., Ed, 37-75;
Liebner, F., Potthast, A., Rosenau, T., Haimer, E., & Wendland, M. (2008). Cellulose aerogels: highly porous, ultra-lightweight materials. Holzforschung, 62(2), 129-135;
Lohri, C. R., Diener, S., Zabaleta, I., Mertenat, A., & Zurbrügg, C. (2017). Treatment technologies for urban solid biowaste to create value products: a review with focus on low- and middle-income settings. Reviews in Environmental Science and Bio/Technology, 16(1), 81-130;
Long, L.-Y., Weng, Y.-X., & Wang, Y.-Z. (2018). Cellulose aerogels: Synthesis, applications, and prospects. Polymers, 10(6), 623;
Łukajtis, R., Rybarczyk, P., Kucharska, K., Konopacka-Łyskawa, D., Słupek, E., Wychodnik, K., & Kamiński, M. (2018). Optimization of saccharification conditions of lignocellulosic biomass under alkaline pre-treatment and enzymatic hydrolysis. Energies, 11(4), 886;
Masson, O., Rieux, V., Guinebretière, R., & Dauger, A. (1996). Size and shape characterization of TiO2 aerogel nanocrystals. Nanostructured materials, 7(7), 725-731;
Moreno-Castilla, C., & Maldonado-Hódar, F. (2005). Carbon aerogels for catalysis applications: An overview. Carbon, 43(3), 455-465;
Ng, H. M., Sin, L. T., Tee, T. T., Bee, S. T., Hui, D., Low, C. Y., & Rahmat, A. R. (2015). Extraction of cellulose nanocrystals from plant sources for application as reinforcing agent in polymers. Composites Part B: Engineering, 75, 176-200;
Northen Alberta Development Council. (2017, July). Industrial hemp and flax a growing northen Alberta opportunity; https://www.nadc.gov.ab.ca/media/17436/hemp-and-flax-proceedings-report-final.pdf;
Ontario Ministry of Agriculture Food and Rural Affairs. (2009, August). Growing industrial hemp in ontario. http://www.omafra.gov.on.ca/english/crops/facts/00-067.htm;
Pääkkö, M., Vapaavuori, J., Silvennoinen, R., Kosonen, H., Ankerfors, M., Lindström, T., . . . & Ikkala, O. (2008). Long and entangled native cellulose I nanofibers allow flexible aerogels and hierarchically porous templates for functionalities. Soft Matter, 4(12), 2492-2499;
Pargar, F., Talukdar, S., Pal, K., & Zanotti, C. (2020). Hemp Waste Valorization as Biofuel and Cement Replacement in Cement and Concrete Production. Waste and Biomass Valorization, 1-11;
Phanthong, P., Reubroycharoen, P., Hao, X., Xu, G., Abudula, A., & Guan, G. (2018). Nanocellulose: Extraction and application. Carbon Resources Conversion, 1(1), 32-43;
Placet, V., Méteau, J., Froehly, L., Salut, R., & Boubakar, M. L. (2014). Investigation of the internal structure of hemp fibres using optical coherence tomography and Focused Ion Beam transverse cutting. Journal of Materials Science, 49(24), 8317-8327;
Ranalli, P., & Venturi, G. (2004). Hemp as a raw material for industrial applications. Euphytica, 140(1-2), 1-6;
Salam, A., Venditti, R. A., Pawlak, J. J., & El-Tahlawy, K. (2011). Crosslinked hemicellulose citrate-chitosan aerogel foams. Carbohydrate Polymers, 84(4), 1221-1229;
Saskatchewan Flax Development Commission. (2020a). The flax industry. https://www.saskflax.com/industry/index.php?page=15;
Saskatchewan Flax Development Commission. (2020b). Flax uses. https://flaxcouncil.ca/growing-flax/chapters/flax-straw-and-fibre/;
Sehaqui, H., Salajková, M., Zhou, Q., & Berglund, L. A. (2010). Mechanical performance tailoring of tough ultra-high porosity foams prepared from cellulose I nanofiber suspensions. Soft Matter, 6(8), 1824-1832;
Sen, T., & Reddy, H. J. (2011). Various industrial applications of hemp, kinaf, flax and ramie natural fibres. International Journal of Innovation, Management and Technology, 2(3), 192;
Song, J., Chen, C., Yang, Z., Kuang, Y., Li, T., Li, Y., . . . & Hu, L. (2018). Highly compressible, anisotropic aerogel with aligned cellulose nanofibers. ACS nano, 12(1), 140-147;
Sun, H., Bi, H., Lin, X., Cai, L., & Xu, M. (2020). Lightweight, anisotropic, compressible, and thermally-insulating wood aerogels with aligned cellulose fibers. Polymers, 12(1), 165;
Svagan, A. J., Azizi Samir, M. A., & Berglund, L. A. (2007). Biomimetic polysaccharide nanocomposites of high cellulose content and high toughness. Biomacromolecules, 8(8), 2556-2563;
Thai, Q. B., Le, D. K., Luu, T. P., Hoang, N., Nguyen, D., & Duong, H. M. (2019). Aerogels from wastes and their applications. JOJ Mater. Sci, 5(555663), 10-19080;
Trilokesh, C., & Uppuluri, K. B. (2019). Isolation and characterization of cellulose nanocrystals from jackfruit peel. Scientific reports, 9(1), 1-8;
USDA Foreign Agricultural Service. (2019, August 26). Industrial hemp production trade and regulation. https://apps.fas.usda.gov/newgainapi/api/report/downloadreportbyfilename?filename=Industrial%20Hemp%20Production%20Trade%20and%20Regulation_Ottawa_Canada_8-26-2019.pdf;
Van Dam, J., & Gorshkova, T. (2003). Cell walls and Fibers|Fiber formation;
Wang, S., Lu, A., & Zhang, L. (2016). Recent advances in regenerated cellulose materials. Progress in Polymer Science, 53, 169-206;
Wicklein, B., Kocjan, A., Salazar-Alvarez, G., Carosio, F., Camino, G., Antonietti, M., & Bergström, L. (2015). Thermally insulating and fire-retardant lightweight anisotropic foams based on nanocellulose and graphene oxide. Nature nanotechnology, 10(3), 277-283;
Wojnowska-Baryła, I., Kulikowska, D., & Bernat, K. (2020). Effect of bio-based products on waste management. Sustainability, 12(5), 2088;
Worsley, M. A., Pauzauskie, P. J., Olson, T. Y., Biener, J., Satcher Jr, J. H., & Baumann, T. F. (2010). Synthesis of graphene aerogel with high electrical conductivity. Journal of the American Chemical Society, 132(40), 14067-14069;
Yamashita, J., Ojima, T., Shioya, M., Hatori, H., & Yamada, Y. (2003). Organic and carbon aerogels derived from poly (vinyl chloride). Carbon, 41(2), 285-294;
Yan, L., Chouw, N., & Jayaraman, K. (2014). Flax fibre and its composites-A review. Composites Part B: Engineering, 56, 296-317;

### BRIEF SUMMARY OF THE INVENTION

The object of the present invention resides in upcycling the fiber residues to high value lignocellulose/cellulose-rich products).

In a first embodiment of the invention, the above-mentioned object is solved by a process for the manufacturing of bio-based aerogels derived from crystalline cellulose extracted from plants' fiber residues, by
(a) hydrolyzing said plants' fiber residues with an aqueous alkaline solution, neutralizing, washing and drying the cellulose fibers obtained,
(b) optionally bleaching said cellulose fibers with an aqueous alkaline solution comprising an oxidizing agent, neutralizing, washing and drying the cellulose fibers obtained,
(c) reacting said cellulose fibers with or without urea in an aqueous alkaline solution to prepare a cellulose solution and
(d) prepare the bio-based aerogel in particulate or monolithic form by known gelation means.

### BRIEF DESCRIPTION OF THE DRAWINGS

The present invention is illustrated and described herein with reference to the drawings, in which any like reference numbers denote like method steps and/or system components, respectively, and in which:

FIG. 1 illustrates scanning electron microscopic images showing fiber thickness of cellulose-rich raw product.

FIG. 2 illustrates scanning electron microscopic images showing the microstructures of bead form of cellulose aerogels prepared from (a) unretted hemp fibers, (b) unretted flax fibers and (c) retted flax fibers after treated with alkali hydrolysis and bleaching.

FIG. 3 illustrates scanning electron microscopic images showing the microstructures of bead form of cellulose aerogels prepared from flax stem after alkali hydrolysis and bleaching.

FIG. 4 illustrates scanning electron microscopic images illustrating the microstructures of monolithic form of cellulose aerogels prepared from (a) unretted hemp fiber, (b) retted hemp fiber, (c) unretted flax fiber and (d) retted flax fiber after alkali hydrolysis and bleaching.

FIG. 5 illustrates scanning electron microscopic images showing the microstructure of unretted hemp fiber-reinforced cellulose aerogel monoliths.

FIG. 6 illustrates scanning electron microscopic images showing the microstructures of unretted flax fiber-reinforced cellulose aerogel monoliths.

FIG. 7 is a graph illustrating a comparison of FTIR spectra of (a) raw hemp fibers, (b) purified cellulose fibers, (c) cellulose aerogels and (d) hemp fiber-reinforced cellulose aerogels.

FIG. 8 is a graph illustrating a comparison of powder X-ray diffraction patterns of purified cellulose after alkali hydrolysis and bleaching and the cellulose aerogels, and particularly relates to a Powder XRD data of cellulose products: (a) native cellulose after alkali treatment and bleaching showing the characteristic cellulose I diffraction peak, (b) cellulose beads and (c) cellulose fiber-reinforced monolithic aerogel.

FIG. 9 is a graph illustrating the powder X-ray diffraction data of the extracted cellulose rich fibers after Exp7, and particularly relates to a Powder X-ray diffraction data of cellulose rich product extracted from retted flax fibers (a) and retted hemp fibers (b) after Exp7; employing bleaching (Exp2) in the product (b) showing no further change in crystallinity (c).

### DETAILED DESCRIPTION OF THE INVENTION

Again, the object of the present invention resides in upcycling the fiber residues to high value lignocellulose/cellulose-rich products.

In a first embodiment of the invention, the above-mentioned object is solved by a process for the manufacturing of bio-based aerogels derived from crystalline cellulose extracted from plants' fiber residues, by
(a) hydrolyzing said plants' fiber residues with an aqueous alkaline solution, neutralizing, washing and drying the cellulose fibers obtained,
(b) optionally bleaching said cellulose fibers with an aqueous alkaline solution comprising an oxidizing agent, neutralizing, washing and drying the cellulose fibers obtained,
(c) reacting said cellulose fibers with or without urea in an aqueous alkaline solution to prepare a cellulose solution and
(d) prepare the bio-based aerogel in particulate or monolithic form by known gelation means.

In step d), any method known from the prior art for preparation of aerogels can be used. Preparation of aerogels typically includes gelation of the solution and subsequent drying of the gel under supercritical and/or ambient conditions. However, the invention is not limited to a particular method of aerogel preparation.

The step (b) of bleaching is optional. Preferably, the inventive method comprises bleaching step (b).

The inventive method preferably does not comprise any purification step or any regeneration step of the cellulose fibers.

In the present invention, in particular, hemp and flax fibers were used as agricultural residues and aimed to prepare cellulose-based aerogels. However, the present invention is not limited to these plants but may be realized in the same way with other fibers based for example on seeds, leaves, straw and/or bast.

The invention herein in particular is a bio-based aerogel derived from crystalline cellulose extracted from plants' stem fiber residues, particularly flax and hemp bast fibers. The resulting aerogel products ranged from continuous sheets (obtained from flax fiber residues), or beads (obtained from hemp fiber residues). The core of this approach lies in the high percent recovery of nano-cellulose fibers from biomass residual materials. The invention is directed towards reducing the high manufacturing cost of aerogels which is a major limiting factor in their commercialization and large-scale production. In addition, it is the aim to produce biocompatible, biodegradable, and thermally stable bio-aerogel that can have various application as insulators, medical materials, and aerospace materials.

Cellulose can be extracted using the alkali hydrolysis followed by bleaching. Cellulose raw products can be dissolved in solvent medium of NaOH-urea-water. Cellulose solution having low viscosity or cellulose having degree of polymerization ≤350 can be used in particular in the particulate form of aerogels production. Low crystalline cellulose rich raw products can also be used in the preparation of particulate form of aerogels. Cellulose solution having high viscosity or cellulose having degree of polymerization ≥350 can be used in particular in the monolithic form of aerogels production. Hemp or flax fibers after alkali treatment can be used in the fiber-reinforced aerogels production. In this case two different crystalline products can be present in the aerogel sample. In the final aerogel product, no traces of lignin or hemicellulose was identified which was confirmed by FTIR spectra. The crystallinity of the cellulose rich extracted products can be varied by employing different reaction conditions as explained in particular in the examples (Exp1 and Exp2 or Exp7).

Lowering the crystallinity of the cellulose makes the solution preparation step easier than preparing solutions from very high crystalline cellulose fibers.

A preferred embodiment of the invention is characterized in that retted and/or unretted fiber residues being used. The benefit of using retted fibers is the high content of crystalline reinforced structure leading to high mechanical strength of aerogels. The benefit of using unretted fibers is to provide less reinforced raw structures. Adjustment of mechanical strength is available by combining the retted and unretted raw materials.

Preferably, the process of the invention uses stems of hemp and/or flax, in particular flax and/or hemp bast fibers. The benefit of using stems of hemp and/or flax, is disclosed in the paragraph mentioned above.

A further embodiment of the invention is seen in the manufacture of reinforced bio-based aerogels according to the process of claim 1 by adding fiber and/or particulate material into step (a) and/or (b). The benefit is to use extracted cellulose fibers having less/no lignin and hemicellulose components.

In a further preferred embodiment of the invention the fiber and/or particulate material comprises, in particular consists of cellulose fibers. The benefit for this is seen in that lignin and hemicellulose or other components in plants influence the gelation process and the final properties of cellulose. The cellulose rich fibres can be processed to make high value aerogel materials. It must be necessary to produce high quality fine cellulose materials considering the applications in medical and food industries.

In an alternative embodiment, the step (b) of the process may be omitted and fibers of raw agricultural fibers and/or particulate material of cellulose are directly employed in steps (a), (c) and (d). In this embodiment, particularly a randomly connected network of microfibers may be formed.

In a further preferred embodiment of the invention the aerogel products range from continuous sheets, in particular from flax fiber residues, or beads in particular from hemp fiber residues.

The present invention further relates to Bio-based aerogels derived from crystalline cellulose extracted from plants' fiber residues, obtainable by a process as defined above. Benefits are in particular the high quality of the processed products.

The present invention provides aerogels as valuable product in particular from hemp and flax fiber wastes (agricultural residues) is new in this field of research. Easy, economically feasible and environmentally friendly methods were developed.

Cellulose I and Cellulose II fiber extraction methods from NaOH solution either by heating at 60° C. or cooling at −20° C. were reported without any additional complicated procedures. Mostly in literatures, the extraction of cellulose processes was reported from NaOH solution or alkali solutions together with complicated additional acid (highly concentrated) treatment procedures. Additional point, in industries cellulose I was considered as the valuable product and not cellulose II. Cellulose II extraction was considered in different literatures but not by the cooling method.

Cellulose extractions have been carried out until now by mechanical, enzymatic, chemical (acid and/alkali) treatments or combination of two of those treatments. Scientists and industries focused on the extraction of cellulose I, because it has high strength and robust mechanical properties. It can be used as starting material for regenerated cellulose (i.e., cellulose II), reagent for many derivatives of cellulose and on of the components for biocomposites synthesis.

The present invention thus provides a novel method for the direct extraction of cellulose II from fibers without any additional step or any purification. In methods know from the prior art, extraction of cellulose II requires an extraction and complicated regeneration. The present invention particularly provides chemical treatment (NaOH-water system, cooling, urea or without urea) for delignification and removal of other non-cellulose-based organic matter. It is an easy removal of any non-cellulose content in plant wastes. It has surprisingly been found that addition of urea may enhance the degradation of crystallinity forming pure cellulose II; in the absence of urea, cellulose may be obtained with a crystallinity of mixture of cellulose I and cellulose II.

Particularly, it has been found that when hydrolysis (step a)) is carried out at temperature of 15 to 100° C., preferably 40 to 70° C., particularly 60° C., in the absence of urea, cellulose I may be extracted form plant fibers, particularly hemp and flax fibers. Hydrolysis (step a)) at a temperature of between −196 to 0° C., preferably −50 to −10° C., particularly −20° C., facilitates the direct extraction of cellulose II without further purification. Addition of urea enhances the degradation of crystallinity forming cellulose II. Thus, in the absence of urea, cellulose was obtained with crystallinity of cellulose I and cellulose II and when using urea, cellulose II was obtained.

For the hemp and flax fibers, NaOH treatment (EXP1, EXP2 or EXP7) is good enough. If there are any traces of lignin and hemicellulose present, they can be removed while preparing the aerogels using the NaOH-Urea-Water as solvent medium.

Aerogels can be produced from Cellulose I and Cellulose II fibers. Crystallinity degraded cellulose (by EXP7) provides mostly low viscous solutions and the fiber length and thickness are relatively thinner and smaller than high crystalline cellulose fibers (by EXP1 and EXP2).

Cellulose fibers with high crystallinity can be used to prepare novel sponge like cellulose aerogels (EXP6a). These sponge porous materials can be used as template or supporting material of composite materials syntheses. EXP6b is a method of demonstration how these fibers can be used in the fiber-reinforced polysaccharide aerogel composites preparation.

For the gelation/regeneration of cellulose/lignocellulose/cellulose rich wet-gel network from cellulose/lignocellulose/cellulose rich solution, water/alcohol/acid containing water and/alcohol mixture can be employed as gelation/regeneration bath. The acid concentration can be varied between 0.1-3 M.

In general, out of hemp and flax fibers, aerogels in the form of particles/beads or monolithic forms can be prepared depending upon the crystallinity and the degree of polymerization.

### EXAMPLES

### Experiments and Methods

Sodium hydroxide, potassium hydroxide, urea and hydrogen peroxide were obtained from Fischer Scientific. Microcrystalline cellulose (medium fiber, degree of polymerization 180-220 and long fibers, degree of polymerization >350) were obtained from Sigma Aldrich. Cellulose MN 2100 powder was obtained from Macherey-Nagel which is a native fibrous cellulose, purified grade with average degree of polymerization 620-680 and has fiber length of 20-75 um. The specific surface of cellulose MN 2100 powder according to Blaine is reported to be 0.55 m²/g. Distilled water was used for the synthesis of gels and ethanol (99%) having 1% of methyl ethyl ketone or petroleum ether was used for solvent exchange process. Cellulose powder was obtained from J. RETTENMAIER & SÖHNE GMBH+CO KG, with a degree of polymerization about 350. Cellulose powder from Alfa Aesar was obtained with a degree of polymerization 180-200.

With the reference material (commercial Cellulose MN 2100 powder), it is demonstrated that the fibers with a thickness in the range (20-75 um) and degree of polymerization >600 can be used in the EXP6a and EXP6b to produced fiber-reinforced cellulose aerogels with sponge structure or as supporting materials in the composite's syntheses.

With the reference material (cellulose medium fiber, sigma Aldrich, degree of polymerization 180-220 or microcrystalline cellulose from Alfa aesar with a degree of polymerization 180-200), it is demonstrated that cellulose fibers can be used for the preparation of cellulose aerogel particles or beads.

With reference material (cellulose from J. RETTENMAIER & SÖHNE GMBH+CO KG, degree of polymerization about 350 or cellulose long fibers from sigma Aldrich with a degree of polymerization >350), it is demonstrated that the cellulose monolithic samples can be prepared in the form of sheets or big blocks (10 cm diameter and 5 cm height cylinders).

### Extraction of Cellulose-Rich Raw Product

### Exp1: Alkali Hydrolysis

In a round bottom flask, 50 g of plant residues (hemp/flax) fibers were soaked in 1800 g of sodium hydroxide (8 wt. %) solution and left to stand for 16 hours at room temperature. The mixture was heated at 60° C. for 3 hours. After cooling to room temperature, the mixture was neutralized with acetic acid. The fibers were collected by filtration. Further they were washed several times with distilled water until the supernatant turned to be colorless. Then they were washed with ethanol (technical grade, 99%) and acetone. Finally, the fibers were oven dried at 50° ° C. The yield was 75-80%.

### Exp2: Bleaching

The product from step 1 was taken in a round bottom flask containing 1800 g of potassium hydroxide (5 wt. %) solution. To this mixture, 90 mL of hydrogen peroxide in water (30%) was added and gently stirred. The mixture was left to stand at room temperature for 16 hours. During this period, the fibers were turned to be dull white in color. To complete the bleaching process, the mixture was heated at 60° C. for 3 hours. After cooling to room temperature, the mixture was neutralized with acetic acid, washed with water, ethanol and acetone and oven dried. The yield was about 85-90%.

### Synthesis of Cellulose Aerogels

### Exp3: Preparation of Cellulose Solution

7 g of sodium hydroxide was dissolved in distilled water (81 g) which is an exothermic reaction. After cooling to room temperature, cellulose fibers were added, and the suspension was stirred for about 10 minutes. Then the mixture was cooled in an ice bath to 0° C. It was stirred for an hour and to this mixture 12 g of urea was added. The dissolution of urea is an endothermic reaction. The stirring was continued for an hour and then left stirring at room temperature. At room temperature, the mixture was observed to be opaque. Then it was stored at −20° C. for 18 hours. After bringing the mixture to room temperature, it appeared to be pale yellow clear viscous liquid.

### Exp4: Preparation of Cellulose Aerogel in Particulate Form (Beads)

3 wt. % of cellulose solution of unretted hemp, unretted flax and retted flax fibers were employed for the beads production. The cellulose solutions were prepared by the method reported above (see Exp3). The drop height between nozzle tip and the surface of the regeneration bath was set about 0.8 to 1.3 cm in the case of unretted and retted flax fibers. The drop height for unretted hemp fiber was about 18 cm. In the case of retted hemp fibers, the viscosity of the solution was much higher than unretted hemp fibers when the raw fibers were employed in the same procedure with the same condition. In order to make beads out of retted hemp fibers, they were treated once again in the Exp1 with alkali solution. Then it was employed in the solution preparation, the viscosity of the solution was reduced. Then the solution was employed in dropping technique for the beads production. The drop height of this solution was 0.5-0.8 cm. The beads were prepared by dropping the aqueous alkali solution of cellulose into the aqueous acetic acidic medium. The beads were collected after 30 minutes of reaction time in acidic medium and washed several times with water until the supernatant of the washed solution turned to be neutral. Then the aqueous medium was exchanged with ethanol. The alcogels were supercritically dried in order to obtain aerogels.

### Exp5: Preparation of Monolithic Form of Cellulose Aerogels Including Disc and Cylinder Forms

5 wt. % of cellulose solution of unretted and retted hemp and flax fibers were employed in the production of monolithic forms. The cellulose solutions were prepared by the method Exp3. The solution was brought to room temperature and stirred for a while in order to make the solution to be homogeneous. Then the solution was transferred to molds and warmed at 50° C. for 30 minutes. After cooling to room temperature, the solution (viscous liquid) was layered with acetic acid (10 wt. %) in technical ethanol (99% ethanol containing 1% of petroleum ether or methyl ethyl ketone). The volume of the mixture of acetic acid and ethanol was approximately equal to the volume of the cellulose solution. The gelation happened by the neutralization and the rate of diffusion of acid through the alkali solution of cellulose controlled the gelation rate. It took about 5 hours to 24 hours depending upon the thickness of the sample and diffusion rate. The wet gels in monolithic form were prepared and washed several times with water until the supernatant of the washed solution turned to be neutral.

Then the aqueous medium was exchanged with ethanol. The alcogels were supercritically dried in order to obtain aerogels.

### Exp6: Preparation of Monolithic Form of Cellulose Fiber-Reinforced Cellulose Aerogels

Hemp or flax fibers were used as raw material or after Exp1 in this experiment. Example of retted flax fiber was described below. In an alternative, it can be prepared also from raw product using the same procedure. It is included here after experimenting in the laboratory. After employing this procedure from EXP 6a, cellulose-rich or lignocellulosic aerogels have been obtained.
(a) 5 wt. % of cellulose rich fibers were taken in sodium hydroxide (7 g) and water (81 g) mixture and stirred at room temperature for 30 minutes. Then the mixture was cooled and stirred at 0° C. in an ice bath for an hour. Then the mixture was stored at −20° C. for 24 hours. The swollen cellulose-NaOH-water mixture was warmed to room temperature. Again the mixture was cooled and stirred at 0° C. To this swollen celluloseNaOH mixture, 12 g of urea was added, and stirring was continued for an hour. Then the mixture was stored again at −20° C.
(b) 6 wt. % of cellulose powder (extracted from hemp or flax after Exp2 or microcrystalline cellulose medium fibers from Sigma Aldrich or Alfa aesar having degree of polymerization ≤400) was added to the dispersion of retted flax fiber (5 wt. %) in 7 wt. % of sodium hydroxide and water (81 g) mixture at room temperature and stirred for 30 minutes. Then the mixture was cooled to 0° C. in an ice bath for an hour. This mixture was stored at −20° C. for 24 hours and warmed to room temperature. Then urea (12 g) was added to the dispersion of cellulose-NaOH-water at 0° C. under stirring. After an hour, the dispersion was stored at −20° C. After 24 hours at −20° C., the mixture was warmed to room temperature and taken in the molds. The samples were warmed in an oven at 50° C. for 3 hours.
(c) After 24 hours at −20° C., the mixture (a) or (b), cellulose-NaOH-urea-water, was warmed to room temperature and taken in the molds. The samples were heated at 70° C. for 3 hours in an oven. The gelation occurred. In the case of (a), the gel was reversible. At room temperature standing the gels for 24 hours, they were turned to be dispersion. In the case of (b), week or hard gel was prepared. Depending upon the degree of microcrystalline cellulose, the gel was observed to be reversible or irreversible.
(d) After 24 hours at −20° C., the mixture (a) or (b) was warmed to room temperature and ultrasonication for 2 hours at 70° C. The gelation occurred. In the case of (a), the gel was reversible. At room temperature standing the gels for 24 hours, they were turned to be dispersion. In the case of (b), week or hard gel was prepared. Depending upon the degree of microcrystalline cellulose, the gel was observed to be reversible or irreversible.

Then each sample was layered with 20 wt. % of acetic acid in technical ethanol. The volume of the mixture of acetic acid and ethanol was approximately equal to the volume of the cellulose-NaOH-urea-water mixture. The samples were kept at 50° C. for the complete gelation and reinforcement of fibers. The gelation happened by the neutralization and the rate of diffusion of acid through the alkali solution of cellulose controlled the gelation rate. It took about 5 hours to 24 hours depending upon the thickness of the sample and diffusion rate.

The wet gels in monolithic form were prepared and washed several times with water until the supernatant of the washed solution turned to be neutral. Then the aqueous medium was exchanged with ethanol. The alcogels were supercritically dried in order to obtain aerogels. The clean hydrogels/alcogels or hexane or pentane exchanged gels from Exp 6a were ambiently (air) dried at standard temperature and pressure to obtain xerogels.

Exp 6a, followed by 6c or 6d resulted in a kind of aerogel where the fibers were fused together randomly forming three dimensional network. In between the fibers of different thickness very big macropores were generated. The wet samples were also used for the generation of xerogels, where hydrogel/alcogel or hexane or pentane exchanged gels were dried under ambient drying, as outlined above.

EXP 6b, followed by 6c or 6d resulted in a kind of two component composite aerogels, in which, one component was fibres of raw materials or after Exp 1. This first component brings the microstructure of EXP6a. The second component was commercial cellulose of any art (degree of polymerization <400) or cellulose extracted from after EXP2 or EXP7. This second component filled the macropores which were developed between the microfibres (EXP 6a).

### Exp7: Delignification and Extraction of Cellulose II from Raw Hemp and Flax Fiber Residues

The cellulose raw fibers can be directly converted to cellulose II powder by this following method. Additionally, this step can remove the non-cellulose materials such as lignin and hemicellulose from agricultural residues. In a round bottom flask, 50 g of plant residues (hemp/flax) fibers were soaked in 1800 g of sodium hydroxide (8 wt. %) solution and left to stand at −20° C. for overnight. Then the mixture was warmed to room temperature. The mixture was heated at 60° C. for 3 hours. After cooling to room temperature, the mixture was neutralized with acetic acid. The fibers were collected by filtration. Further they were washed several times with distilled water until the supernatant turned to be colorless. Then they were washed with ethanol (technical grade, 99%) and acetone. Finally, the fibers were oven dried at 50° C. The yield was 75-80%. The product was confirmed to cellulose II crystalline material.

Alternatively, the step of heating at 60° C. for 3 hours and cooling to room temperature may be omitted and the mixture may directly be neutralized with acetic acid at room temperature after cooling to −20° C. overnight. In this process, the addition of urea (12 wt %) to the sodium hydroxide solution before cooling enhanced the extraction of pure cellulose II.

### Results and Discussion

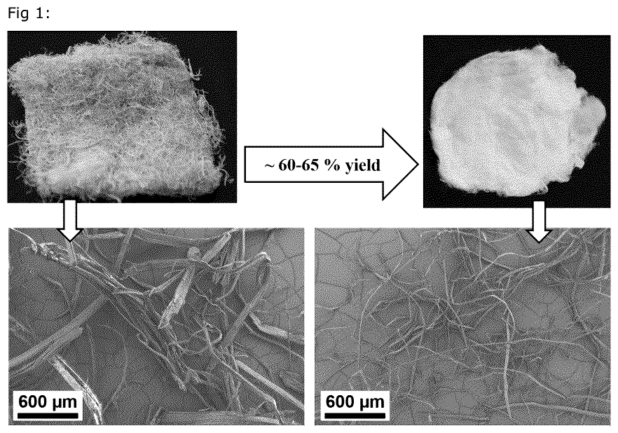

Hemp, flax fibers and flax stem were treated by alkali hydrolysis and bleaching in order to extract cellulose-rich raw products. The yield of cellulose raw product was about 60-65% for hemp and flax fibers. For flax stem, the yield was low that was about 45-50%. During this cellulose extraction process, it was aimed to remove other non-cellulose components such as lignin and hemicellulose. Cellulose rich raw product was white in color (FIG. 1).

FIG. 1 depicts scanning electron microscopic images showing the fiber thickness of cellulose-rich raw product which was about 10-25 um. It seemed that the bundles of fibers were disintegrated into microfibers.

FIG. 1 illustrates the raw hemp fibers and cellulose rich raw products and their corresponding scanning electron microscope images.

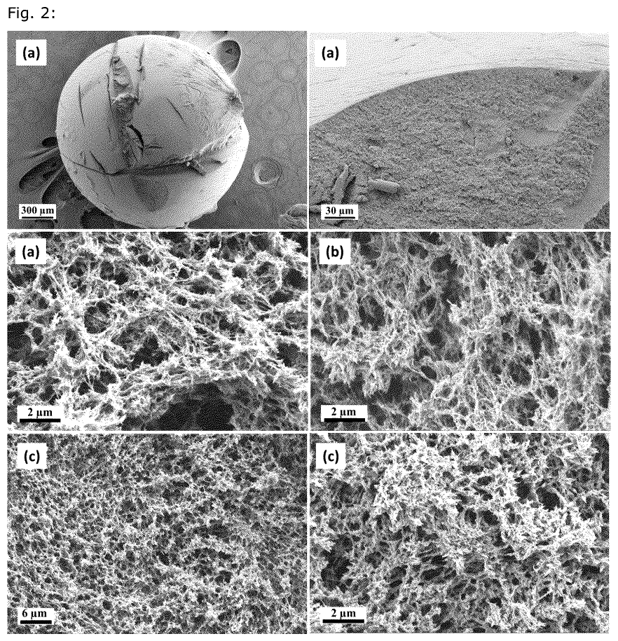

Cellulose beads were prepared from hemp and flax fibers. Scanning electron microscopic images of cellulose beads were shown in FIG. 2. All the samples showed nanofibrillar network of cellulose fibers which is very similar to the classical cellulose aerogels. The specific surface area of the sample from unretted hemp fibers (3 wt. %) was about 200 m²/g.

FIG. 2 illustrates scanning electron microscope images illustrating the microstructures of bead form of cellulose aerogels prepared from (a) unretted hemp fibers, (b) unretted flax fibers and (c) retted flax fibers after treated with alkali hydrolysis and bleaching.

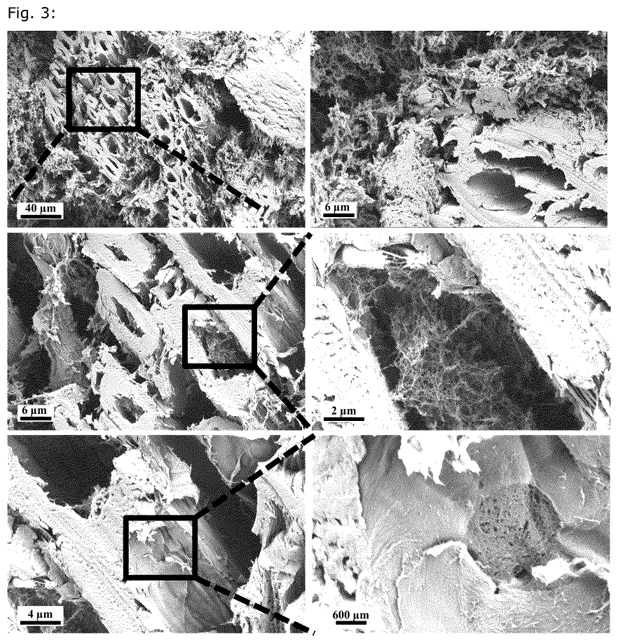

5 wt. % of cellulose rich raw products from flax stem was employed for the beads production. Before beads production, the dispersion was 5 times cooled (−20° C.) and warmed (22° C.). Each time the dispersion was stirred for 5 hours at room temperature. Due to the presence of yellow color wood stem pieces (about 60 wt.), the solution was appeared to be a finely distributed good colloidal dispersion. The wood stem products did not get precipitate even standing the solution for more than 5 hours at room temperature. This colloidal dispersion of cellulose was used in Exp4. The particles/beads of size about 2 mm were prepared and they were rich yellow in color. Scanning electron images were shown in FIG. 3.

The microstructure of FIG. 3 shows two components: hierarchical structure of wood part with macropores of 5 to 10 um and finely distributed cellulose nanofibrillar structure which is similar to classical cellulose aerogels. 100-600 micrometer size of wood parts was embedded in the cellulose aerogel network. The images in the middle row also clearly showed that the cellulose aerogel network can be found in the wood part of flax stem. This implied that the undissolved wood part could have reinforced with cellulose solution which then turned to be interconnected nanofibrillar networks during gelation. The image at the bottom right showed that the wood part could have partially swollen and during regeneration it could have produced the cellulose nanofibrillar network. The tapping density of these cellulose beads was about 0.106 g/mL.

FIG. 3 illustrates scanning electron microscope illustrating the microstructures of bead form of cellulose aerogels prepared from flax stem after alkali hydrolysis and bleaching.

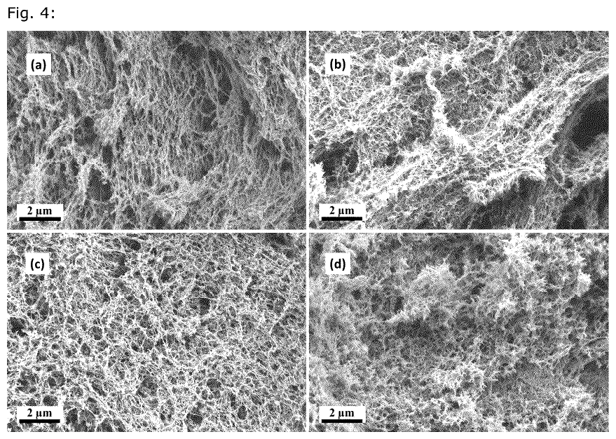

Monolithic form of cellulose aerogels (3 and 5 wt. %) were analyzed. The bulk density was 0.097±0.002 g/mL and 0.18±0.01 g/mL for 3 and 5 wt. % respectively. The scanning electron microscopic images were shown in FIG. 4 for 3 wt. % of cellulose aerogels. The samples showed the interconnected nanofibrillar networks and finely distributed pores.

FIG. 4 illustrates scanning electron microscope illustrating the microstructures of monolithic form of cellulose aerogels prepared from (a) unretted hemp fiber, (b) retted hemp fiber, (c) unretted flax fiber and (d) retted flax fiber after alkali hydrolysis and bleaching.

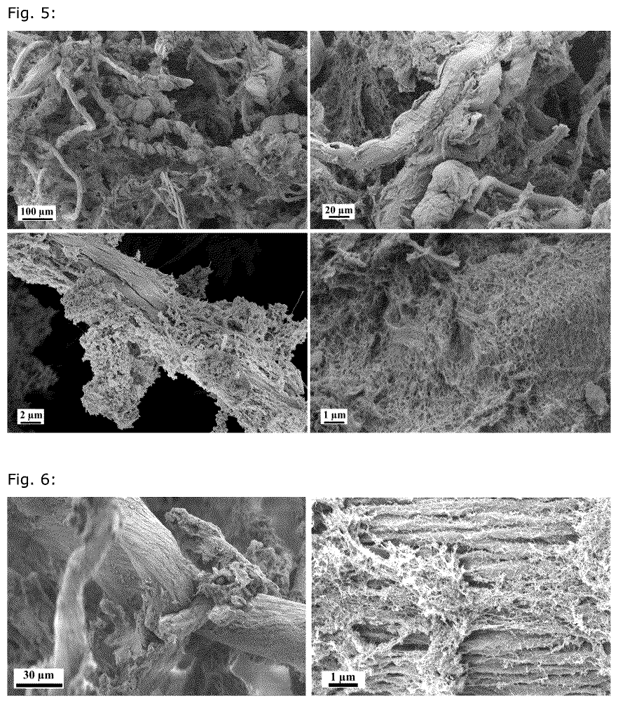

The cellulose aerogels prepared by the EXP6a was observed to be sponge. The bulk density of 4 wt. % of the unretted hemp fibers-reinforced cellulose aerogels was about 0.061+0.02 g/mL. The microstructures of the samples were shown in FIG. 5. The samples were observed to have two components: long fibers of cellulose having thickness in the range about 10-20 um and finely distributed interconnected nanofibrillar network of cellulose. The image suggested that the amorphous regions of cellulose unretted hemp fibers could have dissolved in the solution medium of NaOH-urea-water and high crystalline region of fibers could have swollen or still intact as fibers. The fibers formed knot points in order to make network by the following possibilities: (a) the dissolved cellulose connected the fibers with gel network; (b) the swollen part of fibers fused them with neighboring fibers during neutralization. Ultimately the figures showed that the micro-fibers are reinforced each other to form cellulose aerogels sponge. Mostly the microfibers surface was covered with nanofibrillar networks of cellulose aerogels having mesoporous structure. This product has the specific surface area of 81±2 m²/g and BJH pore volume about 0.5713 cm³/g. The higher the specific surface area could have come from the nanofibrillar network of cellulose. The xerogels of raw fibers (8 wt %) from EXP6a was obtained after air drying. They showed volume shrinkage of 20-25% and the envelope density was about 0.11 g/mL. Only macropores were present, no mesopores were observed. The xerogels showed reversible water adsorption property when the material was made to be wet. No structural deformation occurred. They adsorbed water about 10 times more than their own dry weight. Under wet conditions, they showed flexible property. The xerogels of fibers after EXP1 (5 wt. %) utilized in EXP6a showed the volume shrinkage of 20-30% and the envelope density was in the range between 0.099 and 0.115 g/mL. They showed also no mesopores and the fibers were interconnected forming a network. Under wet conditions, similar to raw fibers mentioned above, they were flexible and adsorbing water molecules 9 to 10 times more than their own dry weight. No deformation occurred even after many cycles of dehydrating and hydrating of xerogels.

FIG. 5 illustrated scanning electron microscope images illustrating the microstructure of unretted hemp fiber-reinforced cellulose aerogel monoliths

FIG. 6 illustrates scanning electron microscope images illustrating the microstructures of unretted flax fiber-reinforced cellulose aerogel monoliths.

The same procedure EXP6a was employed for unretted flax fibers. FIG. 6 showed the microstructures of unretted flax fibers-reinforced of cellulose aerogels. The images showed the nanofibrillar network structures of cellulose aerogel on the surface, microfibers (10-20 um) network and knot points which appeared to be similar to unretted hemp fibers (see FIG. 5).

Cellulose MN 2100 powder was employed in the EXP6a in order to follow the experimental reproducibility for the commercial cellulose fibers having defined properties such as fiber length of 20-75 um and degree of polymerization 620-680. The EXP6a was successful and we obtained monolithic samples from cellulose MN 2100 powders. The specific surface area of the aerogels was 89 m²/g and BJH cumulative pore volume was 0.6623 cm³/g. Comparing these properties with the unretted hemp fiber-reinforced cellulose aerogels, it can be concluded that the methodology EXP6a can provide the same pattern of network and the physical properties such as specific surface area and pore volume could also be in the same range.

EXP6b was performed with commercial cellulose powder together with hemp and flax fibers. Commercial cellulose powder was used more than 5 wt % in order to fil the sponge porous structure of hemp and flax fibers what can be observed in the FIGS. 5 and 6. We expect the physical properties of the aerogels can provide higher values in comparison with the experimental products from EXP6a.

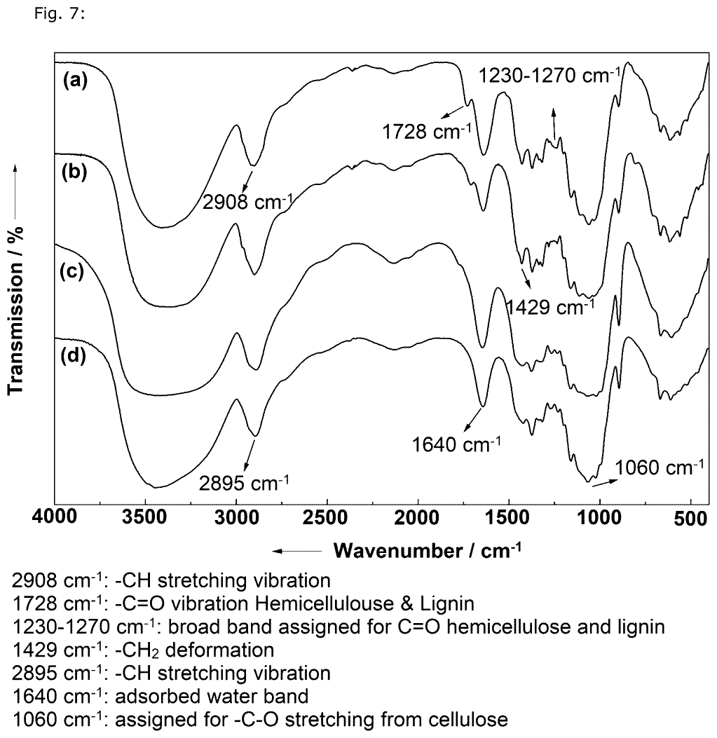

The confirmation of purity was analyzed by FTIR measurements. FIG. 7 shows the comparison of FTIR spectra of raw hemp fibers, purified cellulose fibers and cellulose aerogels. The presence of hemicellulose and lignin showed a strong vibrational band at 1728 cm⁻¹ (FIG. 7a), which corresponds to the —C═O vibrational band. After extraction and purification, the presence of —C═O vibrational band in FIG. 7b indicated that the presence of traces of lignin. The sharp vibration band at 1428 cm⁻¹ in FIGS. 7a and 7b indicated the higher crystalline nature of cellulose which might be cellulose I. In comparison with the IR data of FIGS. 7a and 7b, the aerogels showed the shift of stretching vibrational bands of —CH₂ and —CH bonds at 2895 cm⁻¹ and bending vibrational band of CH2 at 1423 cm⁻¹ (FIGS. 7c and 7d). The vibrational bands in the range between 1010 and 1130 cm⁻¹ were observed to be broader. These changes in the FTIR spectra of aerogels may be caused by the modification of hydrogen bonding, the different orientation of cellulose packing and change in crystallinity.

FIG. 7 shows a comparison of FTIR spectra of (a) raw hemp fibers, (b) purified cellulose fibers, (c) cellulose aerogels and (c) hemp fiber-reinforced cellulose aerogels.

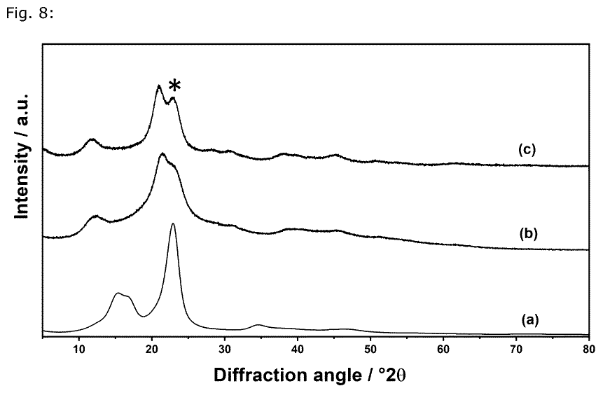

FIG. 8 shows the comparison of powder X-ray diffraction patterns of purified cellulose after alkali hydrolysis and bleaching and the cellulose aerogels. The crystallinity of cellulose mainly depends on the kind of hydrogen bonding (intraand intermolecular) exerted between the cellulose chains and the orientation of packing in the crystal lattice. The diffraction pattern in FIG. 8a revealed the presence of native cellulose, which was assigned to be cellulose I. In the process of aerogel production, physically dissolving it into molecular level and regeneration of fibers by random aggregation, it was converted to cellulose II (FIGS. 8b and 8c). This change in crystallinity is commonly observed in many synthetic pathways while dissolving the native cellulose and subsequent regeneration because of the modified hydrogen bonding and antiparallel orientation of cellulose chains. The hemp fiber-reinforced cellulose aerogels showed a well splitted two diffraction peaks in between the diffraction angles (° 2θ) 20 and 25 (FIG. 8c). The Asterix in FIG. 8c indicated the diffraction peak of cellulose I. Comparing the data of scanning electron microscopic images (FIG. 5), this data implies that there two components present in the samples which are highly crystalline cellulose I (hemp micro-fibers) and low crystalline cellulose II (nanoporous cellulose network).

FIG. 8 relates to a Powder XRD data of cellulose products: (a) native cellulose after alkali treatment and bleaching showing the characteristic cellulose I diffraction peak, (b) cellulose beads and (c) cellulose fiber-reinforced monolithic aerogel. Aerogel materials from (b) and (c) showing the diffraction peaks of Cellulose II. The Asterix in (c) indicates the presence of high crystallinity of cellulose I which is due to the presence of microfibers of cellulose.

It is known from FIG. 8a that high crystalline cellulose fibers (cellulose I) can be extracted after EXP1 and EXP2 in which the fiber suspension was heated at 60° C. for 3 hours with 8 wt. % of NaOH solution. In these processes, trace amount of lignin and hemicellulose were found. With this EXP7, it was planned to degrade the crystallinity of the hemp and flax fibers and at the same time the removal of lignin and hemicellulose was expected. Cooling at −20° C. a mixture of 8 wt. % NaOH and hemp or flax fibers, the cellulose crystallinity can be degraded. Additionally, heating the fiber suspension at 60° C. or bleaching with the procedure (EXP2) has not degraded the crystallinity further. Bleaching can provide white color fibers otherwise the extracted cellulose fibers can be in dull greenish brown color. In this EXP7 urea can also be added in order to enhance the degradation of cellulose crystallinity and removal of lignin and hemicellulose.

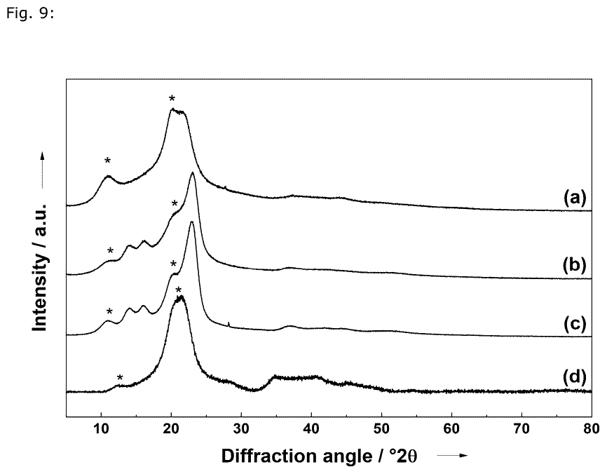

FIG. 9 showed the powder X-ray diffraction data of the extracted cellulose rich fibers after Exp7. In the case of retted flax fibers, cellulose II was obtained (FIG. 9a) whereas in the case of retted hemp fibers a mixture of cellulose I and cellulose II (FIG. 9b) were obtained. Indirectly, it confirmed that hemp fibers have less amorphous cellulose part than flax fibers.

Preparing cellulose aerogels from cellulose II was achieved and the samples should be characterized further. 5 wt % of cellulose solution was prepared from crystallinity degraded retted hemp fibers and retted flax fibers. They were used in the preparation of aerogel beads.

FIG. 9 relates to a Powder X-ray diffraction data of cellulose rich product extracted from retted flax fibers (a) and retted hemp fibers (b) after EXP7. Employing bleaching (EXP2) in the product (b) showing no further change in crystallinity (c). Addition of urea in the process EXP7 enhancing the direct extraction of pure cellulose II from raw retted hemp fibers and showing no impurities of cellulose I (d). The asterisks marked in the graphs indicating the presence of the diffraction pattern of cellulose II.

1. A process for the manufacturing of bio-based aerogels derived from crystalline cellulose extracted from plants' fiber residues, comprising by
(a) hydrolyzing said plants' fiber residues with an aqueous alkaline solution, neutralizing, washing and drying the cellulose fibers obtained,
(b) optionally bleaching said cellulose fibers with an aqueous alkaline solution comprising an oxidizing agent, neutralizing, washing and drying the cellulose fibers obtained,
(c) reacting said cellulose fibers with urea or without urea in an aqueous alkaline solution to prepare a cellulose solution and
(d) preparing the bio-based aerogel in particulate or monolithic form by known gelation means.

2. The process according to claim 1, wherein hydrolyzing in step a) is performed by cooling to a temperature of −196 to 0° C., optionally in the presence of urea.

3. The process according to claim 1, wherein hydrolyzing in step a) is performed by heating to a temperature of 15 to 100° C., optionally in the presence of urea.

4. The process according to claim 1, wherein retted and/or unretted fiber residues are being used.

5. The process according to claim 1, wherein stems of hemp and/or flax, is being used.

6. The process according to claim 1 comprising adding fiber and/or particulate material into step (a) and/or (b) for the manufacturing of reinforced bio-based aerogels.

7. The process according to claim 6, wherein the fiber and/or particulate material comprises cellulose fibers.

8. The process according to claim 1, wherein bleaching is omitted and fibers of raw agricultural fibers and/or particulate material of cellulose are directly employed in steps (a), (c) and (d).

9. The process according to claim 1, comprising by preparing aerogel products ranged from continuous sheets, in particular from flax fiber residues, or beads in particular from hemp fiber residues.

10. Bio-based aerogels derived from crystalline cellulose extracted from plants' fiber residues, obtainable by a process according to claim 1.

11. The process according to claim 2, wherein hydrolyzing in step a) is performed by cooling to a temperature of −20° C.

12. The process according to claim 3, wherein hydrolyzing in step a) is performed by heating to a temperature of 60° C.

13. The process according to claim 5, wherein flax and/or hemp bast fibers is being used.

14. The process according to claim 2, wherein stems of hemp and/or flax, is being used.

15. The process according to claim 3, wherein stems of hemp and/or flax, is being used.

16. The process according to claim 4, wherein stems of hemp and/or flax, is being used.

17. The process according to claim 6, wherein the fiber and/or particulate material consists of cellulose fibers.
